(19) United States
(12) Patent Application Publication
(10) Pub. No.: US 2003/0221305 A1
(43) Pub. Date: Dec. 4, 2003

(54) Tailgate accessory attachment system

(76) Inventor: Donald E. Burg, Miami, FL (US)

Correspondence Address: Robert J. Van Der Wall, McHALE, SLAVIN & VAN DER WALL, First Union Financial Center, Suite 5100, 200 South Biscayne Boulevard, Miami, FL, 33131-2310, US

(21) Appl. No.: 10/158,743

(22) Filed: May 30, 2002

(51) Int. Cl. B23Q 17/00

(52) U.S. Cl. 29/407.1; 29/423; 29/464

(57) ABSTRACT

The invention presented here describes a method of securely attaching accessories to the tailgates of pickup trucks. The preferred method of installation involves use of a positioning device to locate upper fastener(s) that insert blind into the accessory. Forward fasteners are then installed into a forward portion of the accessory to complete the installation. The positioning device may be either discarded or left in place after the installation of the accessory. Pickup truck tailgate accessories that can be mounted using the described attachment system include, among others, a tailgate mounted drag reducing aerostabilizer.

### BACKGROUND OF THE INVENTION

The instant invention describes means of attaching accessories to the tailgates of pickup trucks. Pickup truck tailgate accessories that can be mounted using the herein described attachment system include, among others, the tailgate mounted drag reducing aerostabilizers described in applicant's U.S. Pat. Nos. 5,688,020; 5,871,254; and 6,012,762.

### SUMMARY OF THE INVENTION

A primary purpose of the instant invention is to provide a method for securely attaching an accessory item to an upper portion of a tailgate of a pickup truck.

A related object of the invention is that it include a positioning device for locating the attachment means for the accessory item.

A further related object of the invention is that the positioning device be formed such that it references a forward surface of the tailgate to establish location of the accessory item attachment means.

Yet another related object of the invention is that positioning device is, at least in part, formed in an L-shape.

Another object of the invention is that the accessory item attachment means be affixed to the tailgate at a location established by the positioning device.

A related object of the invention is that a fastener portion of the accessory item attachment means be positioned, as seen with the tailgate vertical, at least three-forth of an inch aft of and no more than one and one-half inches aft of a forward surface of the tailgate proximal to and forward of the fastener portion of the accessory item attachment means.

A further related object of the invention is that a fastener portion of the accessory item attachment means be positioned, as seen with the tailgate vertical, at least one inch aft of and no more than one and one-fourth inches aft of a forward surface of the tailgate proximal to and forward of the fastener portion of the accessory item attachment means.

Yet another object of the invention is that it further includes a fastener portion of the accessory item attachment means.

A directly related object of the invention is that said fastener portion that fastens the accessory item attachment means to the tailgate be a screw-like device.

Still another object of the invention is that the accessory item attachment means fit into an opening in the accessory item.

A related object of the invention is that a receptacle member be disposed in the opening in the accessory item.

A further object of the invention is that there be a locating opening in said positioning device with said locating opening used to position a tool used to make a hole in an upper portion of the tailgate.

Yet another object of the invention is that the accessory item attachment means be, at least in part, curvilinear in shape.

Still another object of the invention is that there be more than one accessory item attachment means.

Another object of the invention is that there be a forward fastener that fastens the accessory item to a forward portion of the tailgate.

It is a related object of the invention that the forward fastener be in mechanical communication with the accessory item and a forward portion of the tailgate proximal said accessory item attachment means.

A further object of the invention is that the forward fastener that fastens the accessory item to the forward portion of the tailgate be a screw-like device.

A further object of the invention is that the forward fastener that fastens the accessory item to a forward portion of the tailgate, as seen with the tailgate vertical, is at least one inch below an upper surface of the tailgate proximal the accessory item attachment means.

Yet another related object of the invention is that the forward fastener that fastens the accessory item to a forward portion of the tailgate, as seen with the tailgate vertical, is at least one and one-fourth inch below an upper surface of the tailgate proximal the accessory item attachment means.

Another object of the invention is that there be multiple forward fasteners that fasten the accessory item to a forward portion of the tailgate.

Still another object of the invention is that the accessory item attachment means includes a seal member.

A directly related object of the invention is that said seal member be at least in part an O-ring.

Yet another object of the invention is that the accessory item attachment means be blind.

A further object of the invention, in one of its optional embodiments, is that the positioning device be discarded after use for positioning the attachment means.

Another optional object of the invention is that the positioning device remains on the tailgate after installation of the accessory item to the tailgate.

A related object of the invention is that at least a portion of the accessory item attachment means be affixed to the positioning device.

An optional object of the invention is that a positioning device for locating and attaching an accessory item on an upper portion of the tailgate further include an accessory item attachment means.

A directly related object of the invention is that, if the positioning device includes the accessory item attachment means, that the accessory item attachment means can be disposed differently than the location requirements given previously in this section.

Still another object of the invention is that the accessory item be an aerostabilizer.

Yet another object of the invention is that said accessory item be an aerostabilizer that includes stanchions that are in communication with the tailgate.

Another object of the invention is that an accessory item attachment means be in mechanical communication with an upper surface of the tailgate and insertable into an opening in the accessory item.

A related object of the invention is that there be a receptacle disposed between the opening in the accessory item and the accessory item attachment means such that the receptacle serves as the opening that the accessory item attachment means inserts into.

### BRIEF DESCRIPTION OF THE DRAWINGS

FIG. 1 shows a portion of a pickup truck with its tailgate closed in the vertical position. Also shown is a positioning device in the form of an angle member here that is used to locate holes used for fasteners in an upper surface of the tailgate. The fasteners are part of an accessory item attachment means that are subsequently used to aid in fastening an accessory item to the tailgate. An electric drill with a drill bit for making the holes is also illustrated. Examination of virtually all makes of pickup trucks has established that the front surfaces and the upper surfaces of their tailgates are perpendicular to each other over at least a portion of their surfaces. This is an important characteristic that has been utilized in developing the instant invention.

FIG. 2 illustrates how the accessory item fastener means, in their preferred embodiment, are attached to the tailgate by sheet metal screws. The electric drill here has a screwdriver bit installed. Note that it is also possible to use self tapping screws in which case there would be no need to drill the holes that was done in FIG. 1.

FIG. 3 shows how the accessory item is then positioned on the tailgate by forcing it down onto the accessory item fastener means. Note that the accessory item shown here is an aerostabilizer that is the subject of earlier patents discussed in an earlier section of this application titled “BACKGROUND OF THE INVENTION”.

FIG. 4 depicts how forward fasteners, here shown as sheet metal screws, are then installed to add strength in the attachment of the accessory item to the tailgate.

FIG. 5 is a similar situation as that presented in FIG. 1; however, in this instance the positioning device will remain on the tailgate after installation of the accessory item. Note the holes for forward fasteners in the positioning device.

FIG. 6 presents a similar operation as FIG. 2 except that the positioning device remains on the tailgate.

FIG. 7 is the same view and operation as that presented in FIG. 3 with the exception that the positioning device remains in place.

FIG. 8 illustrates the completion of the installation of the accessory item as does FIG. 4 except the positioning device remains in place on the tailgate in this FIG. 8.

FIG. 9 is a partial cross sectional view, as taken through the attachment fasteners of FIG. 4, that shows the upper attachment means and its preferred fastener, a sheet metal screw in this instance, and how they insert into the accessory item. Note that a receptacle member, in this case a bushing-like device, is disposed between the opening in the accessory item and the upper attachment means to add structural integrity. Note that the dimensions A and B shown here are used to define the best location of the fasteners on most all pickup truck tailgates.

FIG. 10 shows a similar cross section to that presented in FIG. 9 except a cargo bedliner has been installed that extends up onto the forward surface of the tailgate. The installation of the cargo bedliner does not change dimensions A and B. The A and B dimensions have been established based on a critical review of all pickup truck tailgates both with and without bedliners. Further, an alternative design of the upper attachment means is presented here. This upper attachment means includes an integral fastener and, as a further option, an O-ring that makes for a more secure fit and also acts as a moisture barrier.

FIG. 11 is a partial cross sectional view through a typical fastener system as presented in FIG. 8. In this case the positioning device remains in place as an integral part of the installation of the accessory item.

FIG. 12 presents one more option in the form of a cross sectional view similar to FIG. 11. Note that in this option the accessory item upper fastener means is attached directly to the positioning device. Installation of this configuration would be slightly different that the procedure outlined in FIGS 5 and 6 in that the accessory item upper fastener means are attached to the positioning device before it is installed on the tailgate.

### DETAILED DESCRIPTION

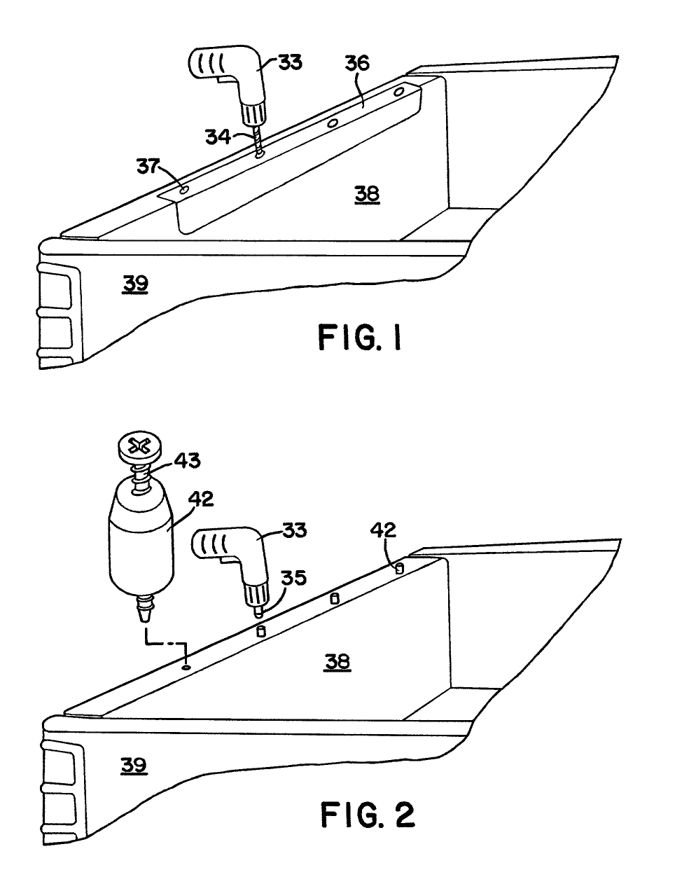

FIG. 1 shows a portion of a pickup truck 39 with its tailgate 38 closed in the vertical position. A positioning device 36 for positioning an accessory on the tailgate 38 is used to locate holes drilled into the top of the tailgate by means of the positioning device's openings 37. This positioning device 36 is normally made in an L-shape so that it can reference either the top and/or the front of the tailgate 38. An electric drill 33 and a drill bit 34 are used for making holes in the tailgate 38 here although any other method for making a hole in the tailgate 38 is acceptable.

FIG. 2 is a similar view to that presented in FIG. 1 except the positioning device has been removed and attachment means 42 for attaching an accessory item to the tailgate are being installed. The preferred embodiment of the attachment means 42 and its fastener 43 are shown in an enlarged view for illustrative purposes. An electric drill 33 and screwdriver bit 35 are shown to illustrate how the attachment means 42 is installed.

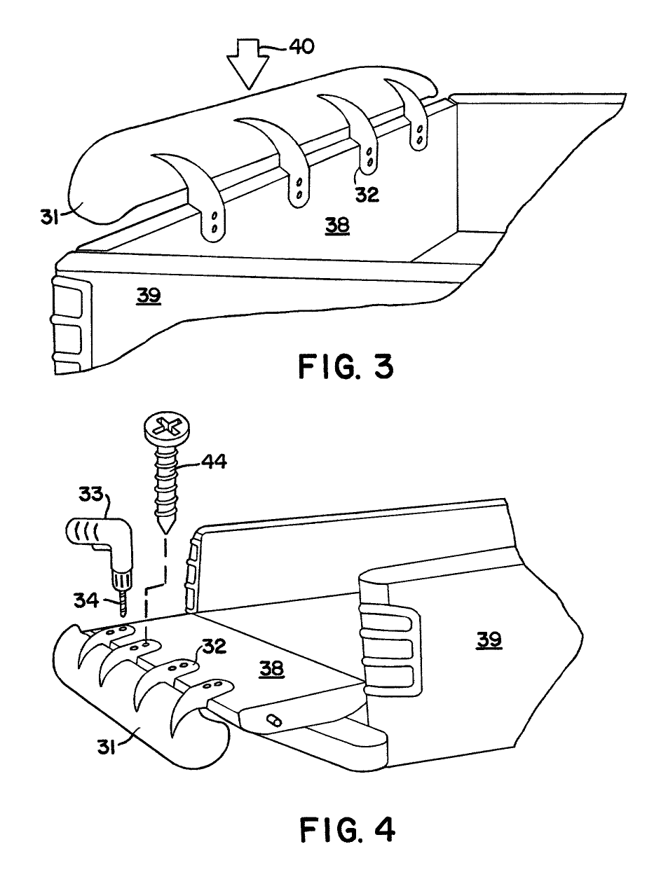

FIG. 3 illustrates how a tailgate mounted accessory 31, in this case an aerostabilizer, is installed by applying a force that is illustrated by force arrow 40. Shown here also are the preferred stanchions 32 that are used as part of Applicant's tailgate mounted aerostabilizers.

FIG. 4 illustrates the preferred method of installing forward fasteners 44, in this case sheet metal screws, to attach the front of the tailgate mounted accessory 31. While the tailgate 38 is shown down or horizontal here, the forward fasteners 44 can be installed with the tailgate 38 in any orientation. Note that the forward fasteners 44 are being installed into stanchions 32 that are part of the tailgate mounted aerostabilizer here. Other tailgate accessories, including other variations of aerostabilizers, may not have the stanchions but would still be considered to be within the spirit and scope of the instant invention.

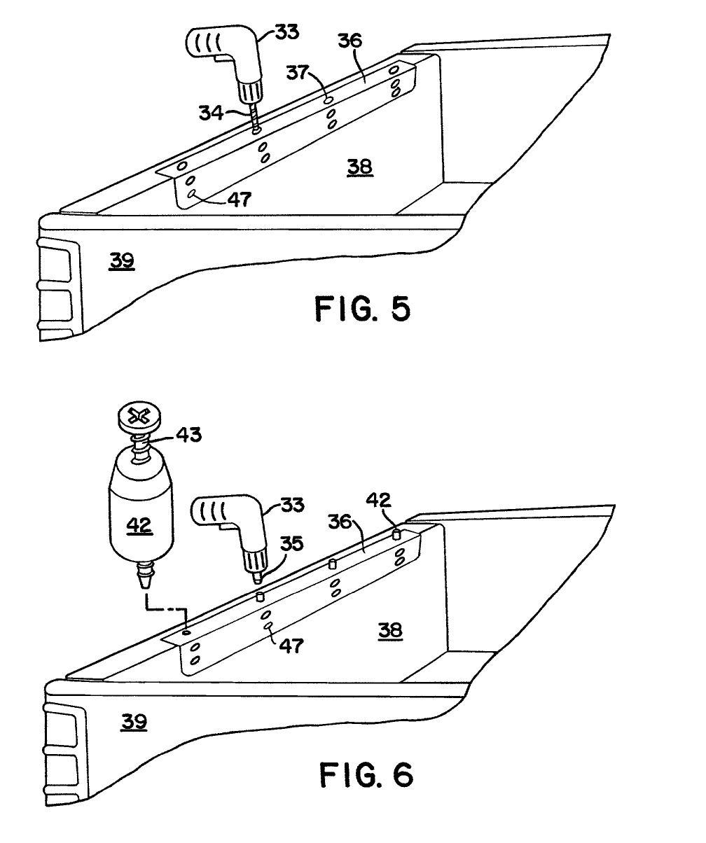

FIG. 5 is essentially the same drawing as presented in FIG. 1 except there are front openings 47 in the positioning device 36. The reason for these openings 47 is that the positioning device 36 stays in place on the tailgate 38 in this concept. As such, the openings 47 are there to allow the forward fasteners to pass through the positioning device 36.

FIG. 6 is the same as the drawing presented in FIG. 2 except the positioning device 36 remains in place on the tailgate 38.

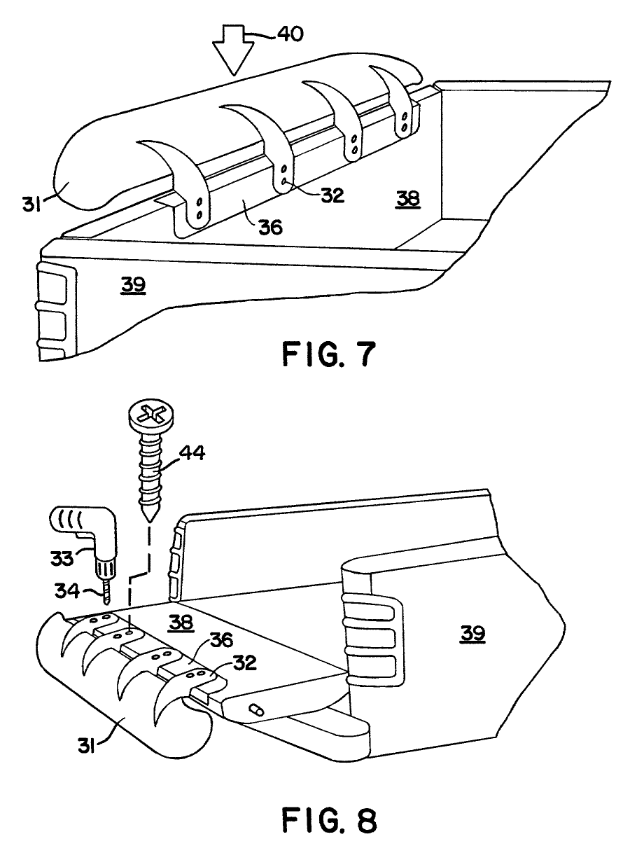

FIG. 7 presents the same drawing as that shown in FIG. 3 but with the positioning device 36 still disposed on the tailgate 38.

FIG. 8 shows the positioning device 36 remaining on the tailgate 38 as the installation of the forward fasteners 44 completes the installation of the accessory item on the tailgate 36.

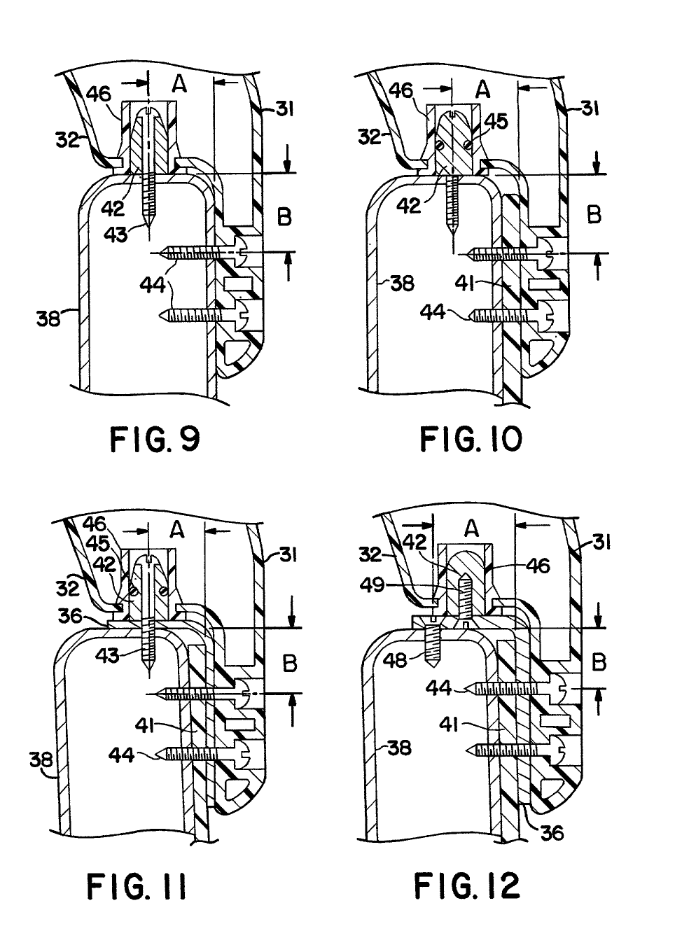

FIG. 9 is a partial cross-sectional view, as taken through a section that includes both the accessory item attachment means 42 and the forward fasteners 44 are located. This also shows an accessory item fastener 43, in this case a sheet metal screw, and a receptacle member 42 that is inserted into an opening in the accessory item 32.

It is important to note that the “A” dimension noted here is critical to meet the width and shape of virtually all pickup truck tailgates. The “A” dimension extends from the forward surface of the tailgate to where a fastener is inserted into an upper surface of the tailgate. The “A” dimension can range between three-fourth to one and one-half inches inch aft of the front surface of the tailgate with a range of one to one and one-fourth inches a preferred range.

The “B” dimension is also important as it was established to also work on virtually all pickup truck tailgates. Both the “A” and “B” dimensions account for different shapes and thickness of tailgates. The “B” dimension extends from an upper surface of the tailgate adjacent a forward fastener 44. The “B” dimension is defined as being at least one inch with one and one-fourth preferred below an upper surface of the tailgate proximal a forward fastener 44.

FIG. 10 presents the same cross-sectional view as did FIG. 9 except for two noted items. First, the accessory item attachment means 42 incorporates a fastening means as part of its structure and also offers a seal 45, in this case an O-ring, that both makes of a more secure connection and also resists moisture penetration into the accessory item. Second, there is a cargo bedliner 41 positioned on the forward side of the tailgate 38. It is important to note that, even with the bedliner 41 in place, the “A” dimension still falls into the same dimensional ranges as given in the preceding discussion about FIG. 9.

FIG. 11 presents similar views and components as FIGS. 9 and 10 except it is based on FIGS. 7 and 8 where the positioning device 36 has been maintained in place.

FIG. 12 offers an alternative installation method to that given in FIG. 11 whereby the positioning device 36 has the accessory item attachment means 42 attached directly to it by a fastener 49. It is to be realized that other means such as swaging, welding, etc. can be used to fasten the accessory item attachment means 42 to the positioning device 36. A separate upper fastener 48 is, in this preferred embodiment of this variation of the instant invention, used to aid in attaching the positioning fixture to the tailgate 38. It is important that the positioning of the upper fastener(s) 48, per noted dimension “A”, can range between three-fourth to one and one-half inches inch aft of the front surface of the tailgate with a range of one to one and one-fourth inches a preferred range.

An advantage to the inventive approaches presented in FIGS. 11 and 12 are that they make for easier more “idiot proof” installations. This is because, since the positioning device 36 remains on the tailgate 38, a novice installer does not have to do any critical locating of fasteners, etc.

A valuable feature of the preferred embodiment of the attachment means 42 shown in FIGS. 9, 10, 11, and 12 is that they are all blind. In these preferred embodiments, there is no direct fastener, such as a screw fastener, that attaches the attachment means 42 to the accessory item 32. The attachment means 42 simply fits into an opening in the accessory item that includes, in these examples, an insert 46. The attachment means 42, whether blind or not, takes at least a majority of the torque forces applied to the tailgate 38 when closing it by applying a lifting force to the accessory item 32. In the ideal case of the instant invention, there is no fastener directly attaching the accessory item 32 to the top of the tailgate 38.

While the invention has been described in connection with a preferred and several alternative embodiments, it will be understood that there is no intention to thereby limit the invention. On the contrary, there is intended to be covered all alternatives, modifications, and equivalents as may be included within the spirit and scope of the invention as defined by the appended claims, which are the sole definition of the invention.

What I claim is:

1. A method for attaching an accessory item to a tailgate of a pickup truck comprising:
a positioning device for locating an accessory item attachment means on an upper portion of the tailgate and said positioning device formed such that it references a forward surface of the tailgate to establish location of the accessory item attachment means.

2. The method of attaching an accessory item to the tailgate of a pickup truck wherein said positioning device is, at least in part, formed in an L-shape.

3. The method of attaching an accessory item to the tailgate of a pickup truck of claim 1 wherein the accessory item attachment means is affixed to the tailgate at a location established by the positioning device.

4. The method of attaching an accessory item to the tailgate of a pickup truck of claim 1 wherein a fastener portion of the accessory item attachment means is positioned, as seen with the tailgate vertical, at least three-forth of an inch aft of and no more than one and one-half inches aft of a forward surface of the tailgate proximal to and forward of the fastener portion of the accessory item attachment means.

5. The method of attaching an accessory item to the tailgate of a pickup truck of claim 1 wherein a fastener portion of the accessory item attachment means is positioned, as seen with the tailgate vertical, at least one inch aft of and no more than one and one-fourth inches aft of a forward surface of the tailgate proximal to and forward of the fastener portion of the accessory item attachment means.

6. The method of attaching an accessory item to the tailgate of a pickup truck of claim 1 which further comprises a fastener portion of the accessory item attachment means.

7. The method of attaching an accessory item to the tailgate of a pickup truck of claim 6 wherein said fastener portion that fastens the accessory item attachment means to the tailgate is a screw-like device.

8. The method of attaching an accessory item to the tailgate of a pickup truck of claim 1 wherein said accessory item attachment means fits into an opening in the accessory item.

9. The method of attaching an accessory item to the tailgate of a pickup truck of claim 8 which further comprises a receptacle member disposed in the opening in the accessory item.

10. The method of attaching an accessory item to the tailgate of a pickup truck of claim 1 which further comprises a locating opening in said positioning device with said locating opening used to position a tool used to make a hole in an upper portion of the tailgate.

11. The method of attaching an accessory item to the tailgate of a pickup truck of claim 1 wherein said accessory item attachment means is, at least in part, curvilinear in shape.

12. The method of attaching an accessory item to the tailgate of a pickup truck of claim 1 wherein there is more than one accessory item attachment means.

13. The method of attaching an accessory item to the tailgate of a pickup truck of claim 1 wherein there is a forward fastener that fastens the accessory item to a forward portion of the tailgate.

14. The method of attaching an accessory item to the tailgate of a pickup truck of claim 13 wherein the forward fastener that fastens the accessory item to the forward portion of the tailgate is a screw-like device.

15. The method of attaching an accessory item to the tailgate of a pickup truck of claim 13 wherein the forward fastener that fastens the accessory item to a forward portion of the tailgate, as seen with the tailgate vertical, is at least one inch below an upper surface of the tailgate proximal the accessory item attachment means.

16. The method of attaching an accessory item to the tailgate of a pickup truck of claim 13 wherein the forward fastener that fastens the accessory item to a forward portion of the tailgate, as seen with the tailgate vertical, is at least one and one-fourth inch below an upper surface of the tailgate proximal the accessory item attachment means.

17. The method of attaching an accessory item to the tailgate of a pickup truck of claim 13 wherein there are multiple forward fasteners that fasten the accessory item to a forward portion of the tailgate.

18. The method of attaching an accessory item to the tailgate of a pickup truck of claim 1 wherein the accessory item attachment means further comprises a seal member.

19. The method of attaching an accessory item to the tailgate of a pickup truck of claim 18 wherein said seal member is at least in part an O-ring.

20. The method of attaching an accessory item to the tailgate of a pickup truck of claim 1 wherein the accessory item attachment means is blind.

21. The method of attaching an accessory item to the tailgate of a pickup truck of claim 1 wherein the positioning device is discarded after use for positioning the attachment means.

22. The method of attaching an accessory item to the tailgate of a pickup truck of claim 1 wherein the positioning device remains on the tailgate after installation of the accessory item to the tailgate.

23. The method of attaching an accessory item to the tailgate of a pickup truck of claim 21 wherein at least a portion of the accessory item attachment means is affixed to the positioning device.

24. The method of attaching an accessory item to the tailgate of a pickup truck of claim 1 wherein said accessory item is an aerostabilizer.

25. The method of attaching an accessory item to the tailgate of a pickup truck of claim 1 wherein said accessory item is an aerostabilizer that includes stanchions that are in communication with the tailgate.

26. A method for attaching an accessory item to the tailgate of a pickup truck comprising:
an accessory item attachment means in mechanical communication with an upper surface of the tailgate, said accessory item attachment means insertable into an opening in the accessory item, and a forward fastener in mechanical communication with the accessory item and a forward portion of the tailgate proximal said accessory item attachment means.

27. The method of attaching an accessory item to the tailgate of a pickup truck of claim 26 which further comprises a receptacle member disposed in the opening in the accessory item.

28. The method of attaching an accessory item to the tailgate of a pickup truck of claim 26 wherein the forward fastener that fastens the accessory item to a forward portion of the tailgate, as seen with the tailgate vertical, is at least one inch below an upper surface of the tailgate proximal the accessory item attachment means.

29. The method of attaching an accessory item to the tailgate of a pickup truck of claim 26 wherein the forward fastener that fastens the accessory item to a forward portion of the tailgate, as seen with the tailgate vertical, is at least one and one-fourth inch below an upper surface of the tailgate proximal the accessory item attachment means.

30. The method of attaching an accessory item to the tailgate of a pickup truck of claim 26 wherein there are multiple forward fasteners that fasten the accessory item to a forward portion of the tailgate.

31. The method of attaching an accessory item to the tailgate of a pickup truck of claim 26 wherein a fastener portion of the accessory item attachment means is positioned, as seen with the tailgate vertical, at least three-forth of an inch aft of and no more than one and one-half inches aft of a forward surface of the tailgate proximal to and forward of the fastener portion of the accessory item attachment means.

32. The method of attaching an accessory item to the tailgate of a pickup truck of claim 26 wherein a fastener portion of the accessory item attachment means is positioned, as seen with the tailgate vertical, at least one inch aft of and no more than one and one-fourth inches aft of a forward surface of the tailgate proximal to and forward of the fastener portion of the accessory item attachment means.

33. The method of attaching an accessory item to the tailgate of a pickup truck of claim 26 wherein said accessory item is an aerostabilizer.

34. The method of attaching an accessory item to the tailgate of a pickup truck of claim 26 wherein said accessory item is an aerostabilizer that includes stanchions that are in mechanical communication with the tailgate.

35. The method of attaching an accessory item to the tailgate of a pickup truck of claim 26 wherein the accessory item attachment means is blind.

36. A method for attaching an accessory item to a tailgate of a pickup truck comprising:
a positioning device for locating and attaching an accessory item on an upper portion of the tailgate and said positioning device formed such that it references a forward surface of the tailgate to establish location of the accessory item attachment means.

37. The method of attaching an accessory item to the tailgate of a pickup truck of claim 36 wherein a forward fastener that fastens the accessory item to a forward portion of the tailgate, as seen with the tailgate vertical, is at least one inch below an upper surface of the tailgate proximal the accessory item attachment means.

38. The method of attaching an accessory item to the tailgate of a pickup truck of claim 36 wherein a forward fastener that fastens the accessory item to a forward portion of the tailgate, as seen with the tailgate vertical, is at least one and one fourth inch below an upper surface of the tailgate proximal the accessory item attachment means.

39. The method of attaching an accessory item to the tailgate of a pickup truck of claim 37 wherein there are multiple forward fasteners that fasten the accessory item to a forward portion of the tailgate.

40. The method of attaching an accessory item to the tailgate of a pickup truck of claim 36 wherein a fastener portion of the accessory item attachment means is positioned, as seen with the tailgate vertical, at least three-fourth inch aft of and no more than one and one-half inches aft of a forward surface of the tailgate proximal to and forward of the fastener portion of the accessory item attachment means.

41. The method of attaching an accessory item to the tailgate of a pickup truck of claim 36 wherein a fastener portion of the accessory item attachment means is positioned, as seen with the tailgate vertical, at least one inch aft of and no more than one and one-fourth inches aft of a forward surface of the tailgate proximal to and forward of the fastener portion of the accessory item attachment means.

42. The method of attaching an accessory item to the tailgate of a pickup truck of claim 36 wherein the accessory item attachment means is blind.

43. A method for attaching an accessory item to a tailgate of a pickup truck comprising:
a positioning device for locating and attaching an accessory item on an upper portion of the tailgate and said positioning device further comprising an accessory item attachment means.

44. The method of attaching an accessory item to the tailgate of a pickup truck of claim 43 wherein the positioning device is formed such that it references a forward surface of the tailgate to establish location of the accessory item attachment means.

45. The method of attaching an accessory item to the tailgate of a pickup truck of claim 43 wherein the accessory item attachment means is blind.

46. The method of attaching an accessory item to the tailgate of a pickup truck of claim 36 wherein an upper fastener fastens the positioning device to an upper surface of the tailgate and said upper fastener is positioned, as seen with the tailgate vertical, at least three-forth of an inch aft of and no more than one and one-half inches aft of a forward surface of the tailgate proximal to the upper fastener.

47. The method of attaching an accessory item to the tailgate of a pickup truck of claim 36 wherein an upper fastener fastens the positioning device to an upper surface of the tailgate and said upper fastener is positioned, as seen with the tailgate vertical, at least one inch aft of and no more than one and one-fourth inches aft of a forward surface of the tailgate proximal to the upper fastener. .

48. The method of attaching an accessory item to the tailgate of a pickup truck of claim 46 wherein there are more than one upper fasteners that fasten the positioning device to the tailgate.

49. The method of attaching an accessory item to the tailgate of a pickup truck of claim 43 wherein a forward fastener fastens the accessory item to a forward portion of the tailgate, as seen with the tailgate vertical, and said forward fastener is at least one inch below an upper surface of the tailgate proximal the accessory item attachment means.

50. The method of attaching an accessory item to the tailgate of a pickup truck of claim 43 wherein a forward fastener fastens the accessory item to a forward portion of the tailgate, as seen with the tailgate vertical, and said forward fastener is at least one and one fourth inch below an upper surface of the tailgate proximal the accessory item attachment means.

51. The method of attaching an accessory item to the tailgate of a pickup truck of claim 49 wherein there are multiple forward fasteners that fasten the accessory item to a forward portion of the tailgate.
